(19) United States
(12) Patent Application Publication
(10) Pub. No.: US 2009/0038242 A1
(43) Pub. Date: Feb. 12, 2009

(54) Bulk materials rapid distribution network and apparatus

(75) Inventor: Ronald Gene Cope, Decatur, TX (US)

Correspondence Address: MELITO, CARL F. , ATTORNEY AT LAW, 12225 GREENVILLE AVENUE, SUITE 700, DALLAS, TX, 75243, US

(73) Assignee: Texsand Distributors, LP

(21) Appl. No.: 11/890,596

(22) Filed: Aug. 7, 2007

(51) Int. Cl. G06Q 10/00; B65G 3/00; B65G 67/00; E04H 7/22

(52) U.S. Cl. 52/192; 414/808; 414/809; 705/1

(57) ABSTRACT

A nationwide bulk materials rapid distribution network and apparatus (i.e. an improved grain elevator) for rapid distribution of any bulk materials including dry bulk, liquids, liquefied gases, and vapor gases is disclosed, comprising the transloading of all kinds of incoming land based pipelines, barges, ships, freight cars, trucks, and grain trailers (hereinafter transport vehicles collectively) unloaded into the receiving means of the apparatus for loading to other transport vehicles through a load out spout emanating from the spout floor on the other side of the grain elevators for dry bulk or by outgoing pipeline to the transport vehicles. The incoming transport vehicles can then be returned to service as quickly as possible for re-deployment, thus minimizing demurrage, and the loaded transport vehicles can be dispatched to the user sites where the materials are needed with minimum delay.

### BACKGROUND

The high cost of fuel has created many challenges for railroads, shippers, and trucking companies to find more cost effective ways of transporting: 1) dry bulk materials such as corn, sugar, sand, coal, rock, cellulosic materials like wood chips and the like, fertilizer, cement, and the like, seed, rock salt, pharmaceuticals, chemicals, commodities, screws, nuts, bolts and the like, but could be anything, like ball bearings, or widgets; 2) liquids like water, gasoline, oil, diesel fuel, trans-fat oil, bio-diesel fuel, refreshments like soda or beer, milk, wine, liquor, and the like, liquefied mixtures of dry materials like cellulosic or liquefied sugar cane, and the like; 3) bulk liquid materials that require special materials like insulated stainless steel pipes, and the like, to store and transport. Examples of such liquids include, blood and blood substitutes and the like, ethanol which absorbs water and harms steal piping systems, hydrogen for hydrogen cars, liquefied natural gas, methane, propane, butane and the like, 4) gaseous materials like natural gas, or carbon dioxide gas; and 5) gaseous materials that require special materials to store and transport such as the insulated, thermos-like, high pressure containers involved in the import and export of liquefied natural gas (LNG), liquefied petroleum gas (LPG), and the like. LPG is the generic name used for mixtures of hydrocarbons like propane and butane. When these mixtures are lightly compressed (approx. 800 kPa or 120 psi), they change from a gaseous state to a liquid state; LPG is colorless, odorless and heavier than air. A chemical is added to give it a smell like rotten cabbage, so that even a very small leak can be easily detected. LPG burns readily in air and has energy content similar to petrol, which makes it an excellent fuel for heating, cooking and automotive use. One automotive use of LPG, called Autogas or LPG Autogas, is specifically designed for vehicle uses and can contain both propane and butane varieties with the specification (or blend) governed by the requirements of the National Fuel Quality Standards Act of 2000 and the Autogas Determination Act of 2003. Hereinafter, the terms “materials” or “bulk materials” are intended to refer to any of the aforementioned bulk materials 1-5, collectively, and should not be confused with the types of materials used to construct pipeline systems and pumping systems and bladders or bladder systems. If in doubt, please look to context of the use of the term “materials”. Transport vehicles for the bulk distribution of bulk materials typically include pipelines, airplanes, ships, barges, freighters, tankers (hereinafter, ships will be used to refer to any kind of sea going vessel like barges, freighters, ferries, tankers, etc.), railroad freight cars (also called hopper cars or gondolas) and rail tank cars (hereinafter freight cars will be used and is intended to mean these and any other kind of rail transport vehicles), trucks, grain trailers, or tank trucks (hereinafter trucks will be defined to mean any kind of trucks, grain trailers, and tank trucks). The bulk materials are usually first obtained by farming, manufacturing or mining. Then they are transported using the transport vehicle most appropriate for the task to some kind of storage facility for later distribution to the ultimate destination. Otherwise the bulk materials simply remain on the pipeline, ship, freight car or truck, in lieu of transfer to temporary storage, until they reach the ultimate user site. Demurrage expenses are the cost of tying up a transport vehicle while waiting to unload or load it, so the focus here will be on the cost of demurrage for pipelines, ships, freight cars and trucks across a nationwide bulk materials distribution network.

Transloading is the process of unloading materials from one type of transport vehicle and loading those materials to another type of transport vehicle. The various methods of unloading shipments have evolved to keep pace with the technological advances of pipelines, ships, freight cars and trucks over the years. Originally, shipments from commercial transport vehicles were unloaded by hand. Eventually, the need for automation of the process became apparent, and various types of scoop shovel conveyors and specialized belt conveyors (hereinafter collectively called pugmills, for consistency) were developed to unload transport vehicles like freight cars and trucks. Other methods of unloading include dropping materials from a freight car through an opening in a bridge and letting it fall onto a pugmill. Still another unloading method that has been employed is to use what is called a rotary car dumper to pick up the freight car and rotate it on its horizontal axis to unload it. Pipelines also evolved out of the need to transport, or otherwise unload, bulk liquids and gaseous materials and have proved to be quite efficient at the task. Ships now transport bulk materials using containers of every type imaginable to suit the type of bulk materials being transported. So to unload bulk materials from ships at the nations ports has become a simple task of lifting containers from the ships with cranes.

The various methods of loading shipments have also evolved to keep pace with the technological advances of pipelines, ships, freight cars and trucks over the years. Originally, shipments from commercial transport vehicles were also loaded by hand. Again, the need for automation of the process became apparent leading to use of the pugmill for loading transport vehicles like freight cars and trucks. A rotary car dumper could also be used to load a barge, or another freight car or truck as well. Loading using a pipeline is different from unloading depending on whether the materials being transported are being introduced into the pipeline system (loading) for transport elsewhere to be removed from the systems (unloading). Similarly, loading a ship with containers is performed by crane as well, so the distinction between the terms “unloading” and “loading” depends on whether the bulk materials are being introduced for transport elsewhere (loading) or are being removed from the ship after the voyage (unloading).

Currently, many companies pay demurrage charges in some way for pipelines, ships, freight cars and trucks that are being used essentially for storage space while waiting to unload or load. Buyers of oil and natural gas must pay for pipeline use, so this too has a cost associated with inefficient transport, and we shall refer to all such costs for any type of transport vehicle's idle time as “demurrage” herein. Freight cars are kept on rail spurs somewhere along the rail network while waiting to be unloaded. When a pugmill becomes available, the freight cars or trucks are unloaded and then returned to their point of origin or sent elsewhere for redeployment. Demurrage charges for freight cars and trucks can be directly charged to the customer. They can also be measured by direct rental charges for the amount of time the transport vehicle is required to complete a job. There is demurrage waiting for a crane to select a container on a ship. Still another measurement for demurrage is the opportunity loss of transport vehicles, and hence workers, being idle. If many trucks are required to move bulk materials, the time it takes to load them grows in proportion to the number of trucks in line. Similarly, freight cars are frequently kept on rail spurs somewhere along the rail network while waiting to be loaded. When a pugmill becomes available, the freight cars or trucks are loaded and then released for transport to the user site.

The Current State of the Fracturing Sand Industry

One example of the potential benefits that can be derived by an improved nationwide bulk materials distribution network can be found in the oil and gas industry. The high demand for oil and natural gas has created an estimated ten-fold increase in the demand for fracturing sand. Fracturing sand is a highly specific variety of sand, used during oil and gas exploration and development to separate subterranean laminae so that the volume flow toward the wellhead is optimal. Although sand mine production has expanded 10 to 20 percent across the U.S. in the quest for new deposits, there continues to be a substantial shortage of fracturing sand at present. It is estimated that the demand will continue at this level for the next 5 to 10 years. Logistic inefficiencies are a tremendous burden on the industry. Mines are able to load freight cars, but service companies have limited space to unload and temporarily store the sand.

Upon delivery, many service companies use the freight cars as temporary storage and unload using portable equipment like pugmills. Pugmills are also used to unload trucks. Some freight cars are so low to the ground (some are as low as a foot) that a hydraulic jack is first used to jack up the freight car so the pugmill can be positioned under it to receive the materials for unloading. Frequently, the demurrage associated with the use of freight cars and trucks to store sand can dramatically increase the cost of the materials to the end user. Additionally, the switching of freight cars causes delays when, for example, twenty cars must wait several days while three cars are unloaded by pugmill. Some gas drilling jobs are postponed, resulting in idle work crews waiting for sand. The answer in the past has been to add more freight cars, which only increases rail congestion along the rail network.

Carbon Dioxide Sequestration

Another example in the oil and gas industry of the potential benefits that can be derived from an improved nationwide bulk materials distribution network is a process called carbon dioxide sequestration where carbon dioxide is removed from the atmosphere and permanently stored. Its purpose is to help mitigate global warming. The first step in sequestration is carbon dioxide capture. All current methods are very expensive to implement. One approach using solid oxide fuel cell power generation significantly reduces carbon dioxide capture costs. Fuel cell systems are now being perfected that will allow separation of carbon dioxide as part of the power generation process. Geological sequestration is the pumping of carbon dioxide into underground saline aquifers and coal oil and gas fields. There is significant evidence to suggest that these techniques can reliably retain sequestered carbon dioxide. Substantial high purity naturally formed carbon dioxide accumulations have been found during exploration and development. Natural systems are great examples demonstrating successful long-term sequestration. One by-product of coal and oil sequestration is methane production. This methane can be recovered and used to offset sequestration costs. The amount of methane is approximately half that of carbon dioxide sequestered. The Dutch government is researching the feasibility of artificial sequestration, and similar pilot projects are underway in the United States and Australia.

Examples abound of the potential benefits that can be derived from an improved nationwide bulk materials distribution network by using the network to advance the exploitation of various advancing technologies for energy conservation and improving the environment. The feasibility of making any bulk materials including, but not limited to, ethanol, methane and hydrogen in an improved grain elevator environment is contemplated herein. Below are just a few more examples of promising new technologies:

Plasma Arc Technology

Plasma arc technology can help to eliminate the necessity of future landfills, which is good for the environment. Experts agree that the nation's population growth will limit space available for future landfills. The Florida Department of Environmental Protection's solid waste division has warned of the increasing difficulty of finding new landfill sites, and it's going to be harder for existing landfills to continue to expand. The plasma arc gasification facility in St. Lucie County, on central Florida's Atlantic Coast, aims to solve that problem by eliminating the need for a landfill. Only two similar facilities are operating in the world, both in Japan. In this example, up to eight plasma arc cupolas will vaporize trash year-round, non-stop. Garbage will be brought in on conveyor belts and dumped into the cylindrical cupolas where it falls into a zone of heat more than 10,000 degrees Fahrenheit. No emissions are released during the closed loop gasification. The only emissions will come from the synthetic gas-powered turbines that create electricity. Even that will be cleaner than burning coal or natural gas, experts say. Few other toxins will be generated, if any at all. The generated electricity that would result by using improved grain elevator silos with adapted bladders specifically made for handling the heat of the process could be used to power the entire improved grain elevator facility. The process also generates methane gas, which can be stored in yet other target silos having bladders specifically adapted for that purpose for temporary storage before loading the methane onto transport vehicles for transport to market.

Biological Water Splitting

Hydrogen will be needed in mass quantities if General Motors has its way. Certain photosynthetic microbes produce hydrogen from water metabolically using light energy. Photo biological technology holds great promise, but because oxygen is a byproduct, the technology must overcome hydrogen-oxygen sensitivity of the evolving enzyme systems that result. Researchers are addressing this issue by screening for naturally occurring organisms that are more oxygen tolerant, and by creating new genetic forms of the organisms that can sustain hydrogen production in the presence of oxygen. A new system is also being developed that uses a metabolic switch called sulfur deprivation to cycle algal cells between a photosynthetic growth phase and a hydrogen production phase.

Renewable Electrolysis

Renewable energy sources such as photovoltaics, wind, biomass, hydro, and geothermal can provide clean and sustainable electricity for our nation. They require energy storage to accommodate daily and seasonal changes. One solution is to produce hydrogen through the electrolysis of water and to use that hydrogen in a fuel cell to produce electricity during times of low power production or peak demand, or to use the hydrogen in fuel cell vehicles. Electricity derived from hydrogen production could power an improved grain elevator as well.

Photo Electrochemical Water Splitting

The cleanest way to produce hydrogen is by using sunlight to directly split water into hydrogen and oxygen. Multifunction cell technology developed by the Photovoltaic industry is being used for photo electrochemical (hereinafter PEC) light harvesting systems that generate sufficient voltage to split water and are stable in a water electrolyte environment. A PEC system produces electricity from sunlight without the expense and complication of electrolyzers, at a solar-to-hydrogen conversion efficiency of approximately 12.4% lower heating value using captured light.

Reforming Biomass and Wastes

Hydrogen can be produced by pyrolysis or gasification of waste materials such as agricultural residues like peanut shells, consumer wastes including plastics and waste grease, or biomass specifically grown for energy production. Biomass pyrolysis produces a liquid product called bio-oil. This bio-oil can be separated into valuable chemicals and fuels, including hydrogen. Research is ongoing on hydrogen production by catalytic reforming of biomass pyrolysis products.

Solar Thermal Water Splitting

Highly concentrated sunlight can be used to generate the high temperatures needed to split methane into hydrogen and carbon. Concentrated solar energy can also be used to generate temperatures over 2,000 degrees causing thermo chemical reactions that can be used to produce hydrogen in an environmentally benign way.

For the foregoing reasons, there is a clear and long felt need for an improved nationwide bulk materials distribution network that achieves the minimum demurrage cost to the customer for rapid transloading (transshipping is another term that means unloading and loading) bulk materials on their journeys to the local destination user sites across the network. Such a network would reduce the overall cost and delay of transporting bulk materials to satisfy any requirement for distribution anywhere in the nationwide network. When a new distribution order is placed to a particular geographic location, immediate attention can be placed on currently scheduled orders, and indeed future orders, to most efficiently direct, or re-direct, bulk materials pickups and deliveries to set at higher priority for selection on those order locations. This way optimum utilization of the network is possible. Under a preferred scenario, the network would contemplate always having a pickup order ready at any given location for the transport vehicle(s) to pickup after their next executed drop off order, at all times across the network to approximate “just in time inventories” for all bulk materials. Such a network must also include abundant temporary storage capacity at each location across the nationwide network to free up many transport vehicles at once during unload phases and to quickly load many transport vehicles upon their arrival during the loading phases at each location. Such a use of temporary storage translates into more efficient overall utilization of pipeline, shipping and rail equipment across the country. Although, it is estimated that most grain elevators of average size can store the contents of over two thousand freight cars, the network should result in fewer, not more, freight cars and trucks being used across the rail network to reduce congestion. The result of such an improved network must be to improve the efficient utilization of pipelines and to shorten trip cycle times for ships, freight cars, and trucks, not to lengthen them.

### SUMMARY

A nationwide bulk materials rapid distribution network and apparatus (i.e. an improved grain elevator) for rapid distribution of any bulk materials including dry bulk, liquids, special liquids like ethanol, liquefied gases, and gaseous materials is disclosed, comprising the transloading of all kinds of incoming pipelines, barges, ships, freight cars, trucks, and grain trailers (hereinafter transport vehicles collectively) unloaded into the receiving means of the improved apparatus, like for instance receiving into its receiver bins for dry bulk materials or by pumping the bulk liquid and gaseous materials of all kinds through pipe systems and bladder systems made of materials like plastic or metals adapted for the particular bulk materials being received, for loading to other transport vehicles through a load out spout emanating from the spout floor on the other side of the grain elevators or other loading means for liquids and gases of various types. The incoming transport vehicles can then be returned to service as quickly as possible for re-deployment, thus minimizing demurrage, and the loaded transport vehicles can be dispatched to the destination user sites where the materials are needed with minimum delay. It is estimated that this invention will save as much as 75% of demurrage and rental charges for transport vehicles and contribute greatly to the alleviation of congestion on pipelines, rail lines, sea lanes and roads.

The present invention is based upon an improved grain elevator apparatus and grain elevator network across the country for the rapid distribution and storage of any bulk materials where they are needed and the infrastructure for the production of any bulk materials where it is contemplated that processing operations could reside adjacent the improved grain elevators across the network. The term “unloading means” hereinafter contemplates the various conventional ways to unload dry bulk materials in addition to pipeline fittings and pump systems for various liquids and gases to connect to, and unload from, sealed bladders (hereinafter, bladders) composed of various materials suitable to effectively store each type of bulk material and which may be held in place within partitioned enclosures, if any, inside the improved grain elevators' silos, or within a whole silo constituting a single enclosure itself, with reinforcing bands or other means of support such as by hanging the bladders or by positioning them within the enclosures in snug fitting relation to the vertical side walls therein to distribute the weight of the unloaded bulk materials against the vertical side walls of the enclosure and/or the silos themselves. When using hardened tanks for any reason, the installation of such a tank requires that the tanks be small enough and light enough to get through the available access to the inside of the silo. Also factors such as weight, associated plumbing, and electronic control and monitoring devices require that there be enough room within the silo to service such devices, repair or replace tanks or “cells”, as well as to remove them or modify them for different usages of the silo. The use of flexible bladders would allow for larger capacities for each bladder since they can be compressed or rolled up like carpet for installation. Even in this instance, the only practical way to have a bladder which is formed to the full dimensions of the inside of the silo is to enter the silo and, after installation of appropriate valves, access means, etc., to spray a rubberized or other type of material onto the sides of the silo. The material should catalyze into something hard or semi-flexible, and now a much larger volume of bulk materials can be stored inside since the bladder would be as large as possible for any given enclosure. A bladder made in this manner would be very difficult to remove or clean, and therefore such a bladder construction is suitable for only limited uses. However this configuration would allow for later installation of a bladder or “cell” system inside such larger bladders without having to remove them. A partial list of candidate materials contemplated for these custom made bladders would include, for the sake of example, but not limited to: metals, alloys, magnesium, titanium, and the like, various types of wood, various types of rubber, polyurethane, plastics, and the like, etc. The term “loading means” hereinafter contemplates the various conventional ways to load dry bulk materials in addition to pipeline fittings and pump systems for various liquids and gases to connect to, and load into, the bladders. These bladders are adapted to be installed in snug fitting relation to conventional grain elevator silo interstices (also called enclosures), or indeed, to an entire silo thus improving the silo. Conventional grain elevators and grain elevator networks received dry bulk materials for the purpose of long-term storage, not for the purpose of optimum distribution to minimize transportation costs. Furthermore, a purpose of conventional grain elevators was to store only dry, granular materials, whereas the present invention is an improved grain elevator and network for storage and distribution of any type of materials (i.e. dry, granular materials, liquids (including ethanol) and gases (including carbon dioxide)). A purpose of the present invention is to minimize demurrage, which conserves fuel and thereby reduces transportation costs, thus reducing the overall cost to ship dry bulk materials across the network. There are 140,000 miles of track in the U.S, and 1.8 billion tons of freight is moved each year by rail. The average freight train burns 350,000 gallons of diesel fuel per year and upwards of seven million gallons over its lifetime. Each freight train engine transports approximately 220 containers. Eleven million containers are transported each year by rail in the U.S., and seven million of those are in Los Angeles and Long Beach, alone. There is no incentive for the railroads to use grain elevators for efficient distribution because the railroad operators make money storing freight on their freight cars. In contrast, there are approximately eleven thousand trucks in operation at any given time. Fuel conservation is also beneficial to the environment. The ordinary use of grain elevator transloading methods was for farmers to unload their grain INTO the grain elevator receiver bins for long-term storage before distribution onto freight cars for transport to the grain's ultimate destination, which is in the opposite direction of the ordinary use proposed by the present invention. In the present invention, the ordinary method of use is to unload FROM the freight cars into the grain elevator receiver bins for subsequent loading onto trucks for transport to the local user sites. So the intended use is quite different as observed by the different problems that are solved, respectively.

Other advantages of the present invention include possible benefits of mobilizing the bulk distribution of materials to areas affected by natural disasters, like for instance: getting blood or blood substitutes to victims of earth quakes; transporting sand to reinforce levees in flooding areas quickly before a coming hurricane; storing crude oil in flood zones to avoid the kind of oil spillage into flooding water that happened during the 2007 Kansas floods from conventional containers; and moving and storing massive amounts of chemicals to areas affected by seasonal forest fires when a need arises. Surely there are military applications for mobilizing food, fuel, blood, and supplies. Still another application is the bulk movement of cellulosic materials like wood chips, or corn, or sugar cane to the heartland where ethanol is made, and then the ethanol itself can be loaded onto the same transport vehicle to be distributed to another destination in the network. Ethanol cannot be transported through oil and gasoline pipelines because it absorbs moisture and impurities. Currently, movement of ethanol through pipelines leads to stress corrosion cracking in the pipes and welds. It has been estimated that the average cost of constructing a conventional line that transports fuels such as gasoline is about $1 million a mile. It will cost more to make ethanol pipelines, since they would have to be made waterproof. Therefore, the present invention may be crucial to ethanol's viability as an alternate fuel source. Still another application is getting food to places experiencing famine, or yet still another application is to move rock salt to an area under an ice storm, or getting medicines including pharmaceuticals to areas of outbreak or epidemic. The improved grain elevator apparatus and network of the present invention could be used for numerous production scenarios, such as: an ethanol refinery, a hydrogen production plant, a carbon dioxide storage and distribution system, a LNG conversion, storage and distribution facility for converting LNG into natural gas and vice versa, a winery, a brewery, a dairy for the production and distribution of milk and soft drink production and distribution. The list goes on. The ultimate purpose of the present invention is the efficient simultaneous unloading and loading (transloading) of any bulk materials through improved storage and production facilities integrated into the improved grain elevator apparatus and network for creating the bulk materials if necessary, and the distribution of those bulk materials across the network.

Historically, farmers, who also had livestock, would grow the feed for their animals. Wheat and corn would be kept in storage buildings such as wheat bins or corncribs. Eventually, these systems of storage evolved into larger facilities, called “granaries”, and were used to store the grain produced by the local communities for market and to be distributed as needed. The term “granaries” is a generic term for any container for grain. Once the automation for unloading grain became widespread, the term “grain elevator” was used to describe the entire building. Thus the grain elevator was born. The basic design and methods of using grain elevators and grain elevator networks have not changed substantially over the years, from the first design in 1883 to the later designs of the twentieth century, and neither has their intended purpose. See U.S. Pat. No. 281,214 W. Watson, Jul. 10, 1883, and U.S. Pat. No. 3,931,877, L. L. Albaugh, Jan. 13, 1976.

Large corporations have used the technology of storing grain for many years to store materials such as wheat for flour or grain for whiskey manufacturing. It has also been used to store materials like cement and fertilizer, and materials imported from foreign countries like coffee, tobacco, or sugar cane. Since the original use and purpose of concrete grain elevators was for storage, that is, a kind of long-term parking lot for grain and occasionally fertilizer, they have fallen into disuse for lack of a continuing need to store grain.

The steel reinforced concrete walls of these structures are about a foot thick, so the explosive properties from materials like hydrogen, LNG, LPG, sulfur and other chemicals, grain dust and fertilizer and the like, are muted. A height of 120 feet is not uncommon. Due to the weight of the concrete, the foundations are massive. The cost of demolishing these “Prairie Castles” is too great to justify the task. This is why the vast majority of grain elevators across the country stand empty. As of 2006, only two elevators were still in use in the ship-based transshipment area near Buffalo, N.Y. The two elevators belong to ADM and General Mills. The grain storage and ship-based transshipment industry here was challenged in the 19th century by the introduction of the train but recovered because of increase in demand. In the 20th century, the requirement for transshipment was eliminated first by the opening of the Welland Canal in 1932, and in 1959 by the opening of the St. Lawrence Seaway. Grain no longer had to be housed in elevators in Buffalo and elsewhere for transfer between modes of transport but could be shipped directly from the heartland to eastern and European ports. Many grain elevators across North America are no longer in use, but they were built to last and remain standing, silent and abandoned.

One example of the distribution network is warranted to demonstrate the immediate commercial success achieved by this improved grain elevator network and its various methods of use:

1) Ottawa/Saint Louis unit train.
2) Cars are loaded at Ottawa Mines and collected at East Saint Louis.
3) It is anticipated that 40 or more cars will collect by Friday of each week.
4) The railroad will pull the cars directly to the grain elevator closest to drop destination during a two or three day trip.
5) The grain elevator operator will unload the freight cars into silos in twenty four to forty eight hours.
6) The railroad returns the cars to the mines and will spot them typically within five days of departure.
7) Eighty percent of the cars will experience a thirteen to seventeen day cycle.

### Typical Grain Elevator Facility Specs:

1) Sixty silos. Each silo will hold 10 freight cars. Current capacity is six hundred freight cars or one hundred and twenty million pounds. A typical grain elevator can store the contents for approximately 2500 freight cars. Silo space leases for approximately $7.50 per ton, whereas freight cars lease for approximately $19.50 per ton.
2) Four rail spurs. The spurs will hold forty cars on the site and can unload up to forty cars per day.
3) Two redundant “legs” for incoming and outgoing materials. There are four scales including two truck scales to weigh the trucks, both empty and loaded, and two hopper scales to weigh the sand as it comes in from rail.

### DRAWINGS

FIG. 1 is a landscape view of a conventional method of unloading a freight car using a pugmill;

FIG. 2 is a landscape view of another conventional method of unloading a transport vehicle using a pugmill that employs a hydraulic cylinder to control a boom;

FIG. 3 is a perspective view of a conventional method of unloading a freight car using a pugmill and a hydraulic jack used to jack up the rail car so the pugmill can fit under it;

FIG. 4 is a hypothetical example of a possible preferred embodiment of an improved grain elevator apparatus according to the present invention for purposes of illustration;

FIG. 5 is a rendering of a freight car being unloaded with a pneumatic hopper car gate door opener into the receiver bin of an improved grain elevator;

FIG. 6 is a landscape view of the various unloading means of the single improved grain elevator of FIG. 4 within the network;

FIG. 7 is a landscape view of the various loading means of the single improved grain elevator of FIG. 4 within the network;

FIG. 8 is a map showing an embodiment of the present invention relating to the Ottawa/Saint Louis unit train example described above in the context of an improved grain elevator network;

FIG. 9 is a map showing an embodiment of the present invention relating to an improved nationwide distribution network of improved grain elevators.

### DESCRIPTION

In the description that follows, like parts are marked throughout the specification and drawings with the same reference numerals, respectively. In some instances, proportions have been exaggerated and are not to scale in order to more clearly depict certain features of the invention. For clarification, the term “metal” is used herein to mean any alloy or steel product that can be used to make pipe systems and bladders (i.e. steel, titanium, magnesium, brass, copper, etc.), and the term “plastic” is used herein to mean any plastics material including polyvinyl chloride (PVC), different types of rubber, polyurethane, and the like. The term “fuel” herein shall mean any type of fuel including gasoline, diesel fuel, butane, methane, hydrogen, LNG, natural gas, ethanol, and the like.

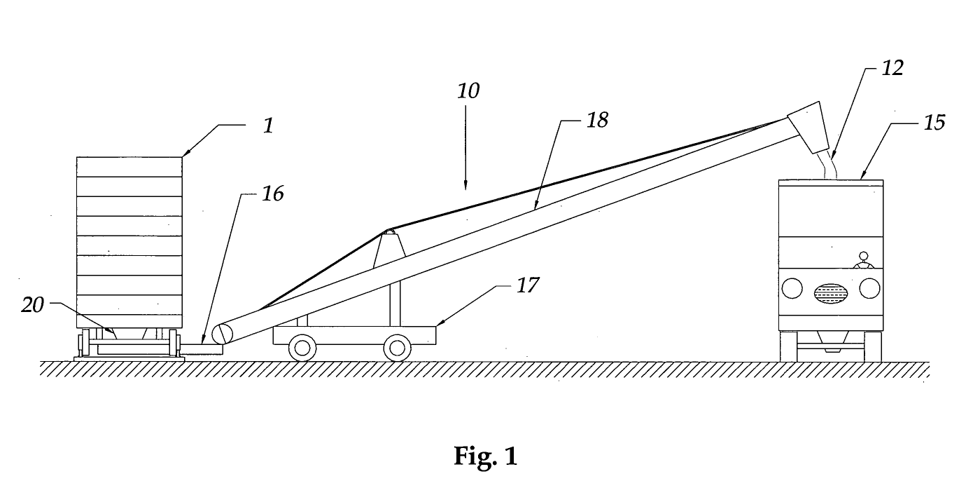

FIG. 1 depicts a conventional method of unloading a freight car 1 or truck (not shown) using a conveyor belt driven apparatus, sometimes referred to as a pugmill 10. A pan 16 of the pugmill 10 is positioned beneath a sliding hopper gate door 20 of the freight car 1. A cart 17, upon which the pugmill 10 rides, is locked into position holding a boom 18 to deposit the material 12 into a waiting truck 15. The pugmill 10 could just as easily unload the freight car 1 to another freight car (not shown), or a truck to another truck (also not shown). Since trucks and grain trailers also have bottom doors 20 for quickly releasing their loads, hereinafter the term “gate door” 20 will be used generically to mean any type of sliding hopper gate door 20 in the context of a freight car and any bottom door for any other transport vehicles, including trucks and grain trailers.

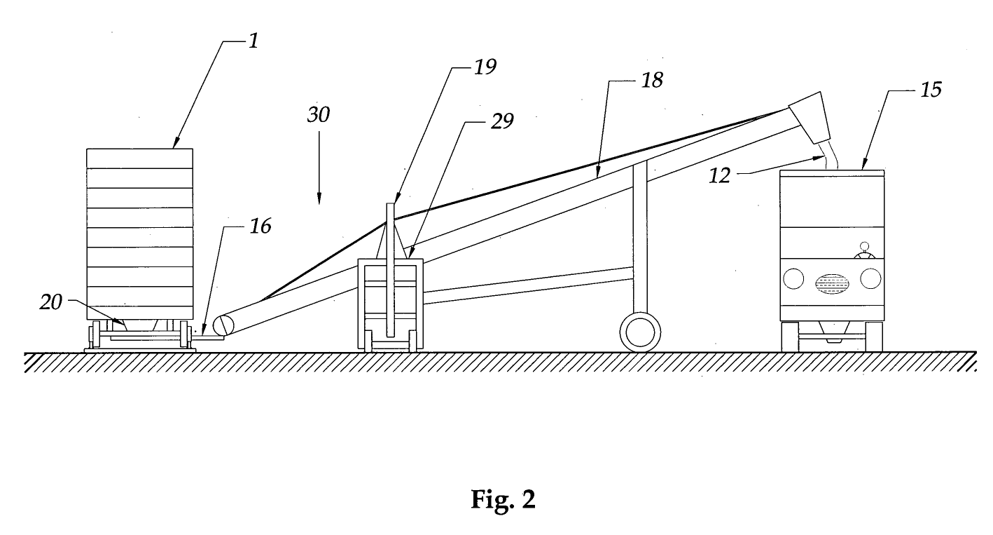

FIG. 2 depicts another conventional method of unloading a freight car 1 or truck (not shown) using another type of pugmill 30 that employs a hydraulic cylinder 19 to control a boom 18. Here, a pan 16 of the pugmill 30 is positioned beneath a sliding hopper gate door 20 of the freight car 1. Another type of cart 29, upon which the pugmill 30 rides, supports the boom 18 and hydraulic cylinder 19 which controls holding the boom 18 to deposit the material 12 into the waiting truck 15 or a freight car (not shown). The pugmill 30 could just as easily unload the freight car 1 to another freight car (not shown), or a truck to another truck (also not shown).

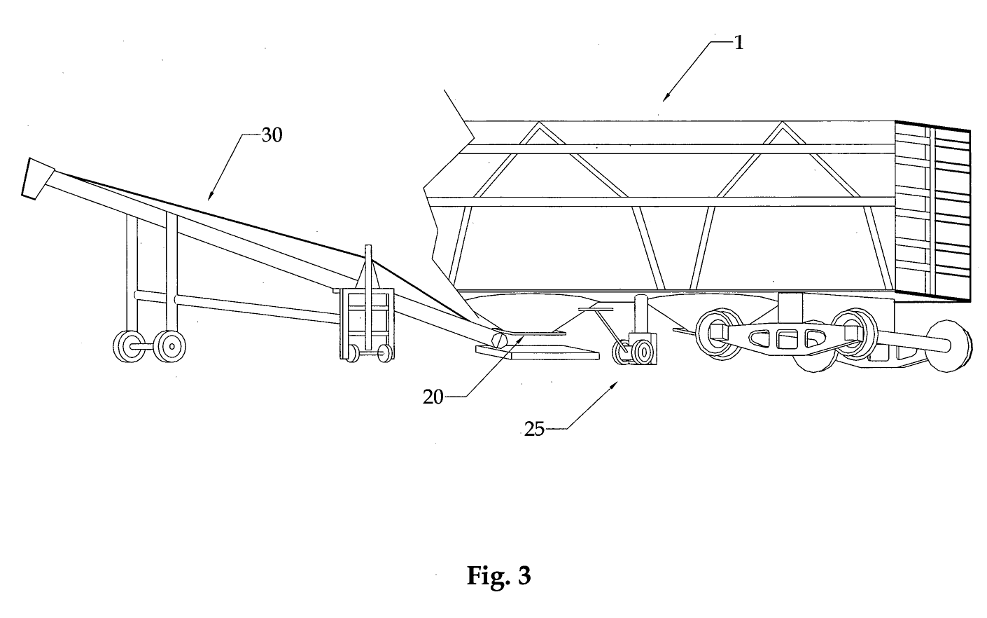

FIG. 3 shows still another conventional method of unloading a freight car 1 using a pugmill 30 and a hydraulic jack 25 used to jack up the freight car 1 so the pugmill 30 can fit under a sliding hopper car gate door 20.

### DETAILED DESCRIPTION OF THE PREFERRED EMBODIMENTS

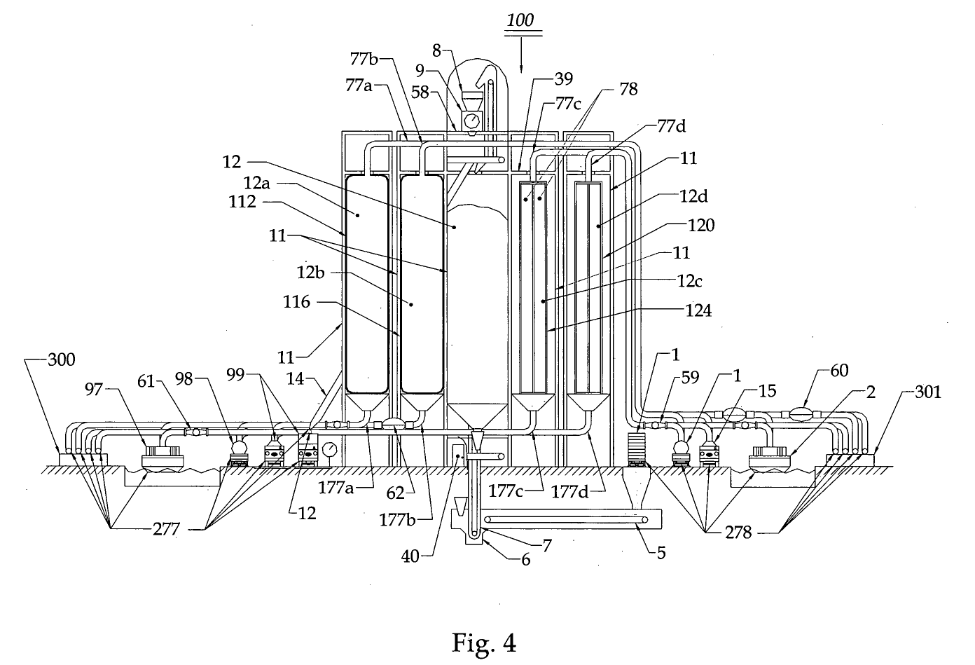

In the material that follows, the terms “unloading means” and “loading means” refer to the structure and tools used and described hereinafter for unloading bulk materials to an improved grain elevator apparatus and loading bulk materials from an improved grain elevator apparatus, respectively. FIG. 4 is an example of a possible embodiment of an improved grain elevator apparatus 100 in the network of the present invention (not shown), which is here shown having only four silos 11 for illustration, but any number of silos 11 is contemplated within each grain elevator apparatus 100. Note that the space occupying the middle of the improved grain elevator 100 directly under hopper scale 9 and scale floor 58, where dry bulk materials 12 are depicted, is not a silo but is formed by the union of the silos 11 on each of its sides. Here we have a first bladder 112 in a silo 11 or an enclosure therein (not shown) specifically designed for storing and distributing, in this case liquefied natural gas (LNG) 12a, a special liquid bulk material because it is under high pressure. FIG. 4 also shows a new method of unloading bulk materials of any kind optionally, or indeed simultaneously, from at least one incoming ship 2, freight car 1 or truck 15. One can imagine water 12c being pumped in by a first incoming pumping station 59 through a first incoming liquid pipeline 77c from a nearby lake or reservoir (not shown) into at least one of the two enclosures 78 depicted within a third bladder system 124. Incoming pipelines are 77a, 77b, 77c and 77d and are in this example for high pressure gases like LNG 77a, low pressure gases like natural gas 12b stored in a second bladder 116, liquids 12c through pipeline 77c and special liquids like ethanol 12d stored in enclosures of a fourth bladder system 120. In like manner, low-pressure gases, like natural gas 12b may use a first incoming gas pipeline specially suited for low-pressure gases using incoming pipeline 77b and a second incoming pumping station 60. At the same time that any number of unloading stations 278 are unloading dry bulk 12 (no bladder) through a horizontal drag conveyor 5 which transports the dry bulk material 12, which in this example would be corn or cellulosic materials used to make ethanol, to a boot 6 of a vertical bucket elevator 7. The vertical bucket elevator 7 then carries the material 12 to a scale floor 58 where it is caught in a garner 8. The garner 8 can feed a hopper scale 9 up to a pre-defined weight, or weighing can be skipped. Then the material 12 is released to the spout floor 39 by force of gravity, where it may be dropped again by force of gravity directly to load out spouts 14 for the loading of outgoing ships 97, trucks 99 or freight cars 98. Outgoing pipelines 177a, 177b, 177c and 177d can use loading stations 277 in similar fashion, but in the example of FIG. 4, only our second (from left to right) outgoing pipeline 177b actually uses a second outgoing pumping station 62 (also from left to right) for pumping since its material is natural gas 12b in the example, and natural gas needs to be pumped while loading at some point. Since the other three bulk materials are liquids in the example of FIG. 4 (i.e. LNG 12a in a first outgoing pipeline 177a, water 12c in a third outgoing pipeline 177c, and ethanol 12d in a fourth outgoing pipeline 177d). Force of gravity does most of the work of pumping for liquids, just as it does for dry bulk materials FIG. 4, 12, again to a certain point, where a third outgoing pumping station 61, for example, may need to be used to move residual water 12c, or there may be back pressure in a third outgoing pipeline 177c (again from left to right in FIG. 4). Our example shows ethanol 12d using a fourth outgoing pipeline 177d and a fourth outgoing pumping station (not numbered in FIG. 4) to load a tanker 97, a truck 99 and a ship 97. Natural gas 12b using a second outgoing pipeline 177b and a second outgoing pumping station 62 to load any number of transport vehicles in any number of loading stations 277, and also onward through an outgoing land based pipeline system 300. Note the incoming land based pipeline system 301 and all other incoming liquid pipelines 77a, 77c and 77d will all require pumping stations since they must move the liquid materials to the top of the silos 11 to unload them from their respective transport vehicles. At ground level is a room 40, which is generally used as a service area devoted to receiving equipment and controls for operating the improved grain elevators 100 in an improved grain elevator network (not shown) and can also serve as a warehouse or office.

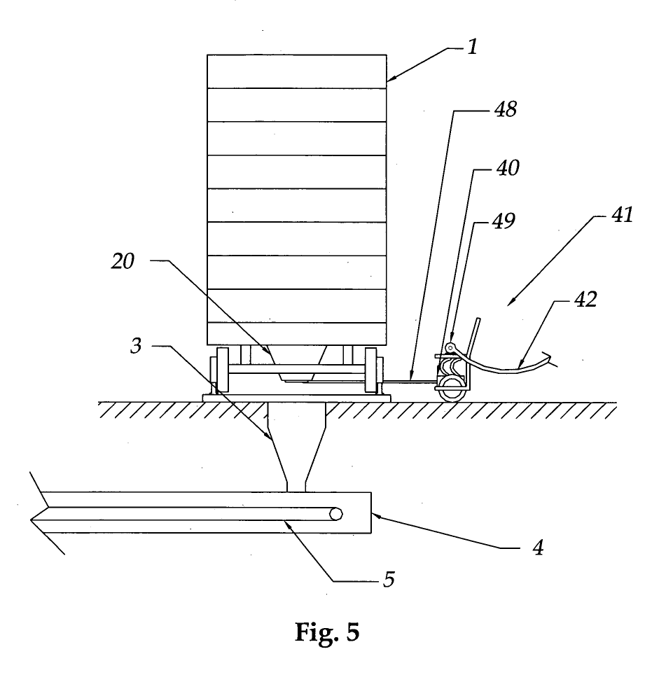

In order to unload dry bulk materials 12 according to the present invention, FIG. 5 shows unloading means suitable for the task. A pneumatic hopper car gate door opener 41 is used in this example (but any method of opening the sliding hopper car gate door 20 is contemplated as an equivalent in this step) to unlatch the sliding hopper car gate door(s) 20. After a freight car 1 or a truck (not shown) is parked at the appropriate spot in an unloading station FIG. 4, 278 over a receiver bin FIG. 5, 3, the door opener 41 uses a hydraulic pump 49, which is powered by compressed air through line 42. The hydraulic pump 49 powers a motor 40, which actuates the shaft 48 unlocking the sliding hopper car gate door(s) 20. The materials 12 then travel through the conveyor belt housing 4 onto a horizontal drag conveyor 5.

FIG. 4 shows the apparatus and distribution processes of the present invention using a single improved grain elevator, but one can imagine many improved grain elevators in the grain elevator distribution network (not shown) of the present invention working in similar fashion showing barges 97, trucks 99 or freight cars 98 with dry bulk materials 12 temporarily stored in improved grain elevators 100, and potentially unlimited simultaneous unloading and loading (transloading) in both directions through the apparatus. Under another embodiment of the present invention that demonstrates both unloading means and loading means, a barge 97, a truck 99 or freight car 98 may be directly loaded from an unloading transport vehicle. In the example of FIG. 4, a freight car 1 is unloaded in the following fashion (unloading means): dry bulk materials are dropped from the freight car 1, into a receiver bin FIG. 5, 3 and the horizontal drag conveyor 5 transports the bulk materials 12 to the boot 6 of a vertical bucket elevator 7. The vertical bucket elevator 7 then carries the material to the scale floor 58 where it is caught in the garner 8. The garner 8 feeds the hopper scale 9 up to a pre-defined weight or weighing may be skipped. Then the material falls to the spout floor 39, where it may be sent directly to load out spouts 14 from an enclosure directly under the hopper scale 9 formed by its surrounding silos 11 for the loading of barges 97, trucks 99 or freight cars 98 (loading means).

Another embodiment of the present invention loads (another loading means) barges 97, trucks 99 and freight cars 98 with dry bulk materials 12 that have been temporarily stored in silos 11 within the improved grain elevators throughout the network in the following fashion: near the bottom of the silos 11, there is a ducting system (not shown) that allows the discharge from any particular silo 11. The discharge is channeled by a distribution system (also not shown) to the boot 6 of the vertical bucket elevator 7 and carried to the garner 8 near the top of the grain elevators 100 in the network. The garner 8 then delivers the bulk materials 12 to the hopper scale 9 up to a pre-defined weight or weighing can be skipped. The bulk materials 12 then fall to the spout floor 39, where they may be sent to the load out spout(s) 14 for loading into barges 97, truck(s) 99 or freight car(s) 98. At this point, a truck scale can measure the weight of the bulk materials so the improved grain elevators 100 can issue a document showing the weight of the various transport vehicles, thereby complying with shipping regulations.

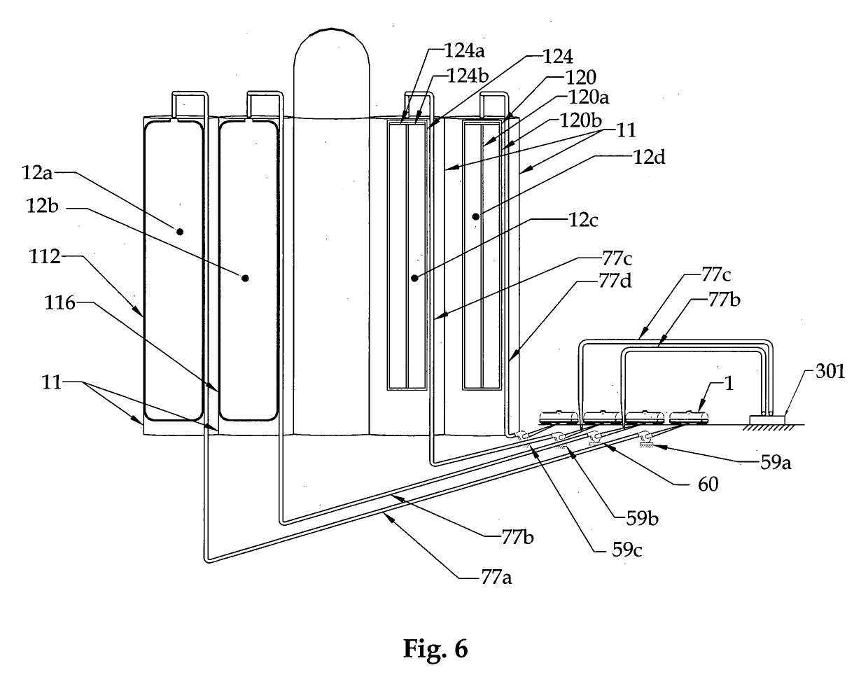

FIG. 6 depicts an isolated view of the example of FIG. 4 demonstrating the unloading means for liquids or gaseous bulk materials of any kind optionally, or indeed simultaneously, from at least one incoming freight car 1 and at least one land pipeline 301. In this case, liquefied natural gas (LNG) 12a, natural gas (LP) 12b, water 12c, and ethanol 12d, can be unloaded into improved silos 11 (hereinafter, the phrase “improved silos 11” is used alternatively with the phrase “silos 11” to emphasize use of bladders in an improved grain elevator network) containing bladders 112, 116, 124 and 120, respectively, custom made to the each type of bulk material. The materials arrive by rail tanker car 1 (generically, freight car is used, but rail tanker car places emphasis on the type of bulk materials) or by land pipeline 301 (“incoming land based pipeline” or “land based pipeline” are alternative expression). Neither ethanol 12d, nor liquefied natural gas (LNG) 12a are transported by land based pipelines 301. Unloading means by way of incoming pipelines 77a, 77b, 77c and 77d can use land based pipelines 301 as transport vehicles, but should not be confused with land pipeline systems. These are pipelines internal to the improved grain elevator, which offload and transport the various materials into the improved silos 11. As stated for this example, high pressure gases like LNG 12a, are offloaded from bulk carrier rail tank car 1 (freight car) via a first pumping control system 59a appropriate for this purpose and sent through pipeline 77a to be stored in a first bladder or bladder system 112.

Low pressure gases like natural gas (LP) 12b, are offloaded from bulk carrier rail tank car 1 (freight car), or from land pipeline 301, by a second pumping control system 60 appropriate for this purpose and sent through pipeline 77b to be stored in a second bladder or bladder system 116. Stable liquids such as water 12c would be offloaded primarily from land pipelines 301, usually from a nearby lake or reservoir (not shown), or under certain conditions offloaded from freight cars. Either source could supply water 12c by a third pumping control system 59b especially adapted for this purpose and sent through pipeline 77c to be stored in a third bladder or bladder system 124 which, in this example is composed of two bladder subsystems 124a and 124b (124a and 124b are simple examples of enclosures within a silo 11, and there can be any number of these enclosures for bladders to occupy). Special liquids like ethanol 12d are offloaded from freight cars 1 by a fourth pumping control system 59c, specifically adapted for this purpose and sent through pipeline 77d to be stored in a fourth bladder or bladder system 120 which, in this example is composed of two bladder subsystems 120a and 120b.

The specific usage of improved silos 11 and bladders or bladder systems 112, 116, 124, 120 demand that their use be designated for silos fitted to accommodate specific materials for which specialized bladders 120, 124, 112, 116 and appropriate measuring (not shown), monitoring (not shown), and handling devices such as pumping control systems 59a, 60, 59b, 59c would be created and installed.

In the case of LNG, its unloading means is a pumping system 59a appropriate for the pumping of LNG would be the unloading means used to offload the material from the incoming LNG freight car 1, and transport the material via dedicated (internal) pipeline 77a into a silo 11 containing bladder system 112 specifically created for this purpose in choice of materials used to construct the bladder system 112. Here we have a first bladder or bladder system 112 in a silo 11 (or an enclosure therein, not shown) specifically designed for storing and distributing liquefied natural gas (LNG) 12a. LNG is a special liquid bulk material because it must be stored and transported under high pressure. A very large steel pressure tank within a single silo 11, or several pressure tanks occupying enclosures within a single bin or silo 11 would be a preferred construction for bladder system(s) 112 optionally having electronically controlled pressure valves (not shown), electronic pressure gauges (not shown), and associated monitoring equipment (not shown) for maintaining the appropriate conditions for LNG bladders 112. All pressure, temperature, and moisture critical elements would be monitored and controlled from within a central control facility FIG. 4, 40.

In the case of ethanol 12d, its unloading means is a specialized pumping system 59c, pipeline 77d, measuring device (not shown), and bladder system 120 would be required for handling problems arising from the unique chemical characteristics of ethanol. Ethanol cannot be transported through oil and gasoline pipelines because it absorbs moisture and impurities. Currently, movement of ethanol through steel pipelines leads to stress corrosion cracking in the pipes and welds. It has been estimated that the average cost of constructing a conventional land based pipeline that transports fuels like gasoline is about $1 million per mile. It will cost more to make ethanol pipelines, since they would have to be made waterproof and resistive to the corrosive effects of the ethanol itself. Therefore, the present invention may be crucial to ethanol's viability as an alternate fuel source.

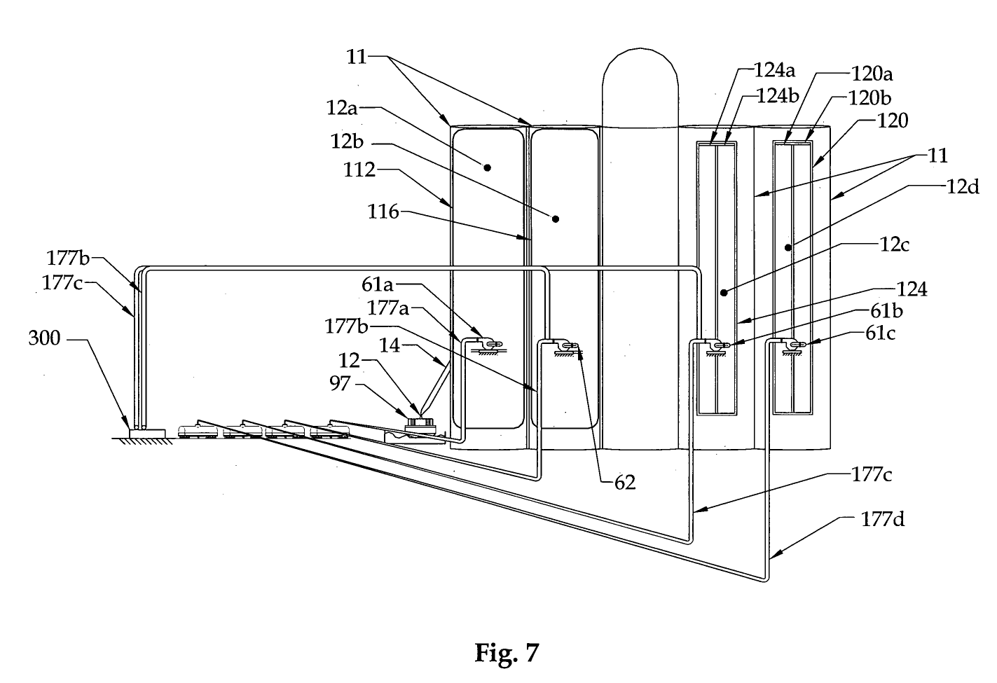

FIG. 7 depicts an isolated view of the present invention demonstrating the loading means of various liquids or gaseous bulk materials, in this case, liquefied natural gas (LNG) 12a, natural gas (LP) 12b, water 12c, and ethanol 12d, from improved silos 11. FIG. 7 also shows a new method of loading liquid or gaseous bulk materials 12 of any kind optionally, or indeed simultaneously, to at least one outgoing freight car 1, at least one land pipeline 300 and at least one outgoing transport barge 97 (ship). Neither ethanol 12d nor liquefied natural gas (LNG) 12a are presently transported by land pipelines 300, so it is unlikely these materials would be transported by current land based pipelines 300, but if new pipelines are layed for ethanol the present invention contemplates transporting it through any such new land based pipelines, and this applies to any other bulk materials. Outgoing pipelines are 177a, 177b, 177c and 177d, which transport the various materials from the improved silos 11. In the case of transport barge 97, a load out spout 14 can load dry bulk materials 12. As stated for this example, high pressure gases like LNG 12a are loaded to rail tank car 1 via a first pumping control system 61a especially constructed and adapted for this purpose and sent through first pipeline 177a from a first bladder or bladder system 112. Low pressure gases like natural gas (LP) 12b are loaded to rail tank car 1, to land pipeline 300, or via a second pumping control system 62 constructed especially for this purpose and sent through second pipeline 177b from a second bladder or bladder system 116. Stable liquids like water 12c can be loaded through a land pipeline 300. Loading means for water 12c could be by loading to rail tank car 1 through a third pipeline 177c or by a third pumping control system 61b especially constructed for this purpose and sent through third pipeline 177c from a third bladder or bladder system 124 which, in this example is composed of two bladder subsystems 124a and 124b. Again transport barge 97 could be loaded with dry bulk materials 12 via load out spout 14 simultaneously or optionally. Special liquids like ethanol 12d are loaded to freight cars 1 via a fourth pumping control system 61c especially constructed for this purpose and sent through a fourth pipeline 177d from a fourth bladder or bladder system 120 which, in this example is composed of two bladder subsystems 120a and 120b.

The specific usage of improved silos 11 and bladders or bladder systems 112, 116, 124, 120 demand that their use be designated for silos 11 fitted to accommodate specific materials for which specialized bladders 120, 124, 112, 116 and appropriate measuring (not shown), monitoring (not shown), and handling devices such as pumping control systems 61a, 62, 61b, 61c would be created and installed.

In the case of LNG 12a, its loading means is a pumping system 61a specially constructed for pumping LNG would be used to load the material to the outgoing LNG rail tanker car 1, and transport the material via dedicated pipeline 177a from a silo 11 containing bladder system 112 specifically created for this purpose. Here we have a first bladder or bladder system 112 in a silo 11 or an enclosure therein (not shown) specifically designed for storing and distributing liquefied natural gas (LNG) 12a, a special liquid bulk material because it is under high pressure. Again a large steel pressure tank (not shown) as the bladder system 112 is contemplated with electronically controlled pressure valves (not shown), electronic pressure gauges (not shown), and associated monitoring equipment (not shown) for maintaining the appropriate conditions for LNG bladder(s) 112. Likewise, all pressure, temperature, and moisture critical elements could be monitored and controlled from within a central control facility FIG. 4, 40.

In the case of ethanol 12d, its loading means is a specialized pumping system 61c, pipeline 177d, measuring device (not shown), and bladder system 120 would be required specifically constructed for the storage and transport of ethanol. Ethanol cannot be transported through oil and gasoline pipelines because it absorbs moisture and impurities. Currently, movement of ethanol through steel pipelines leads to stress corrosion cracking in the pipes and welds. It has been estimated that the average cost of constructing a conventional line that transports fuels such as gasoline is about $1 million per mile. It will cost more to make ethanol pipelines, since they would have to be made waterproof and resistive to the corrosive effects of the material itself. Therefore, the present invention may be crucial to ethanol's viability as an alternate fuel source, but if ethanol pipelines are constructed across the nation, the present invention contemplates loading into them as an alternative embodiment.

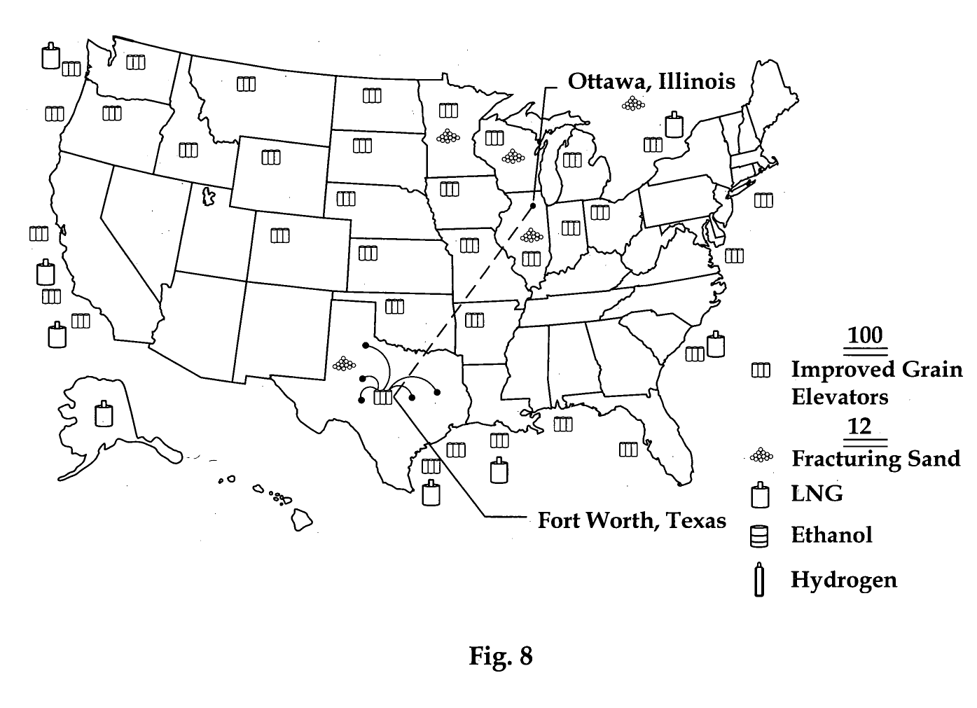

FIG. 8 shows a map that depicts an embodiment of the present invention of an improved network of improved grain elevators 100 relating to the Ottawa/Saint Louis unit train example above. The process described therein describes a unit train departing Ottawa, Ill. with its cargo of fracturing sand which was transloaded from a nearby sand quarry by trucks FIG. 4, 15 through an improved grain elevator 100 nearest the quarry en route to another improved grain elevator 100 in the improved network in Fort Worth, Tex. where the bulk materials 12, in this case fracturing sand, will be unloaded from the freight cars FIG. 4, 1 and loaded to trucks 15 for delivery to local natural gas drilling sites using outgoing transport vehicles FIG. 4, 99. The incoming freight cars 1 are returned to the shipping company and the demurrage fees are minimized. FIG. 8 discloses many abandoned grain elevators across the nation that will be modified to be improved grain elevators 100. They are grouped in the hundreds all across the country. This embodiment of the present invention converts the otherwise useless grain elevators into huge warehouses in an improved nationwide distribution network of improved grain elevators 100 capable of handling any kind of bulk materials, and which can accommodate the contents of potentially thousands of freight cars 1 at any one location. The foregoing map provides a basic example of the layout of an improved grain elevator distribution network whereupon each grain elevator was improved by introducing at least one bladder to conventional grain elevators, with configurations of bladders for various bulk materials as simple or as complex as the type of bulk material requires.

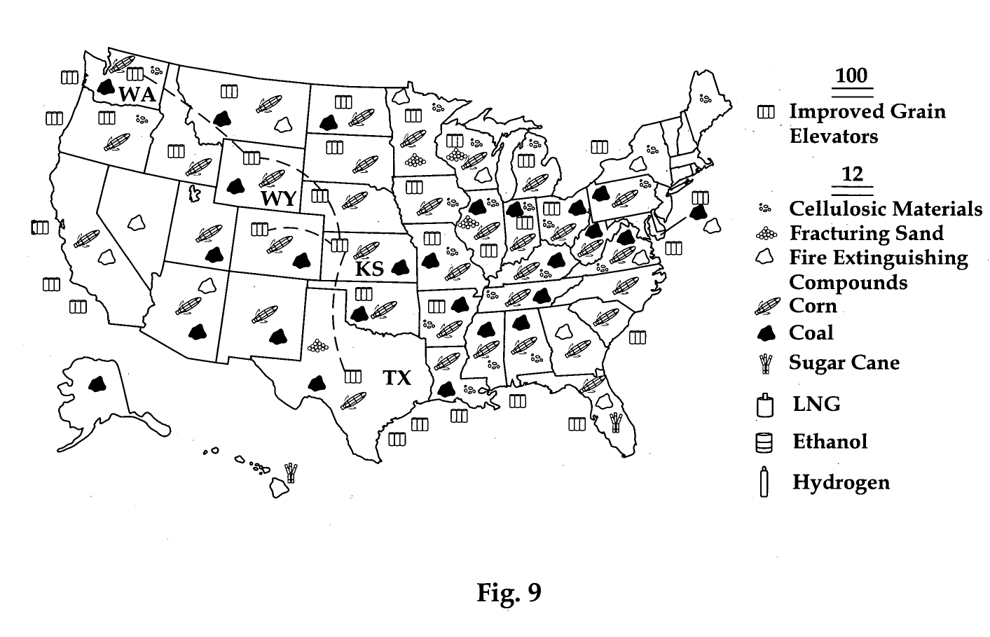

FIG. 9 is a map showing another embodiment of the present invention where the improved network of improved grain elevators 100 of the present invention is spread out across the country. Randomly selected locations of improved grain elevators 100 are depicted as an example of an improved network of grain elevators 100, and where applicable, the different types of bulk materials are placed on the map at different geographic locations across the country where the different kinds of bulk materials 12 can be found in abundance. LNG is imported, so it is depicted in FIG. 9 at the sea based improved grain elevators at or near major national ports. Railroad links between six different improved grain elevators 100 in the improved network shown by the map of FIG. 9 demonstrates how, in this case, dry bulk materials 12 are quickly distributed from any improved grain elevator 100 location in the network to any other improved grain elevator 100 location in the network. For example, the need for coal 12 in the state of Washington could require shipments from Texas. In the example shown, coal could be shipped to Kansas, and meet up with a shipment from Colorado to continue on to Washington. The immediate commercial success exemplified by the fracturing sand example of FIG. 9 shows why utilizing this inexpensive temporary storage, abundantly available in improved grain elevators 100, to store liquids and gaseous materials by means of systems of bladders combined with the flexibility to change configurations as demand for bulk materials changes, has merit. Similar scenarios can be contemplated using bulk materials ethanol and hydrogen as well. FIGS. 8 and 9 are only cursory studies as to the location of improved grain elevators 100 and the states that are the largest producers of the various bulk materials shown. “Just in time inventory” information management system techniques can be employed so that any, arriving transport vehicle throughout the nationwide network of improved grain elevators 100 depicted by the map of FIGS. 8-9 will be automatically assigned to link up deliveries with pickups, where a three way nexus is achieved among locations chosen having abundant availability of the various bulk materials involved for all outstanding delivery orders, availability and cost of alternative transport vehicles that can service those locations, and the available capacity of silo enclosure space and congestion at improved grain elevators 100 nearest those locations.

While the preferred embodiments of the present invention have been described in connection with specific embodiments hereof, and in specific methods of use, various modifications thereof may occur to those skilled in the art without departing from the spirit and scope of the invention as set forth in the appended claims.

The terms and expressions which have been employed in this specification are used as terms of description and not of limitation, and there is no intention whatsoever to exclude any equivalents of the features shown and described, or portions thereof. It is recognized that various modifications are possible within the scope of the invention as claimed. Although the present invention has been described in considerable detail with reference to certain preferred embodiments, other alternative embodiments are possible. Therefore, the spirit and scope of the claims should not be limited to the description of the preferred embodiments in this disclosure, nor the alternative embodiments, contained herein.

What is claimed is:

1. In a grain elevator network, wherein at least one grain elevator is constructed with at least one target silo structure having vertical side walls therein forming at least one enclosure therein for storing unloaded bulk materials, the improvement to provide flexibility in allowing the storage and rapid distribution throughout an improved grain elevator network of any kind of bulk materials, including dry bulk materials, liquid materials and gaseous materials, inside and through said at least one enclosure within said at least one target silo structure within at least one improved grain elevator, comprising a sealed bladder formed to fit inside said at least one enclosure.

2. The invention of claim 1, wherein the sealed bladder is formed to fit inside said at least one enclosure in snug fitting relation to the vertical side walls therein to distribute weight of the unloaded bulk materials against the vertical side walls therein.

3. In a grain elevator constructed with at least one target silo structure having vertical side walls therein forming at least one enclosure therein for storing unloaded bulk materials, the improvement to provide flexibility in allowing the storage and rapid distribution of any kind of bulk materials, including dry bulk materials, liquid materials and gaseous materials, inside and through said at least one enclosure within said at least one target silo structure within an improved grain elevator, comprising a sealed bladder formed to fit inside said at least one enclosure.

4. The invention of claim 3, wherein the sealed bladder is formed to fit inside said at least one enclosure in snug fitting relation to the vertical side walls therein to distribute weight of the unloaded bulk materials against the vertical side walls therein.

5. The invention of claim 3, wherein the sealed bladder is formed of metal and the bulk materials are hydrogen.

6. The invention of claim 4, wherein the sealed bladder is formed of metal and the bulk materials are hydrogen.

7. The invention of claim 3, wherein the sealed bladder is formed of metal and the bulk materials are LNG.

8. The invention of claim 4, wherein the sealed bladder is formed of metal and the bulk materials are LNG.

9. The invention of claim 3, wherein the sealed bladder is formed of metal and the bulk materials are natural gas.

10. The invention of claim 4, wherein the sealed bladder is formed of metal and the bulk materials are natural gas.

11. The invention of claim 3, wherein the sealed bladder is formed of metal and the bulk materials are carbon dioxide.

12. The invention of claim 4, wherein the sealed bladder is formed of metal and the bulk materials are carbon dioxide.

13. The invention of claim 3, wherein the sealed bladder is formed of plastic and the bulk materials are trans fat oil.

14. The invention of claim 4, wherein the sealed bladder is formed of plastic and the bulk materials are trans fat oil.

15. The invention of claim 3, wherein the sealed bladder is formed of plastic and the bulk materials are ethanol.

16. The invention of claim 4, wherein the sealed bladder is formed of plastic and the bulk materials are ethanol.

17. The invention of claim 3, wherein the sealed bladder is formed of plastic and the bulk materials are water.

18. The invention of claim 4, wherein the sealed bladder is formed of plastic and the bulk materials are water.

19. The invention of claim 3, wherein the sealed bladder is formed of plastic and the bulk materials are fuel.

20. The invention of claim 4, wherein the sealed bladder is formed of plastic and the bulk materials are fuel.

21. The invention of claim 3, wherein the sealed bladder is formed of metal and the bulk materials are fuel.

22. The invention of claim 4, wherein the sealed bladder is formed of metal and the bulk materials are fuel.

23. A method of distributing bulk materials across at least one network of improved grain elevators used for temporary storage, through which efficient transloading of incoming transport vehicles to outgoing transport vehicles is performed at least one improved grain elevator physically located across the network to minimize demurrage of both the incoming transport vehicles and the outgoing transport vehicles everywhere in the network, comprising the steps performed at said at least one improved grain elevator across the network of:
(a) stationing the incoming transport vehicles in at least one unloading station of at least one improved grain elevator receiving means to prepare to unload the bulk materials using said at least one improved grain elevator receiving means,
(b) unloading the bulk materials using said at least one improved grain elevator receiving means,
(c) conveying the bulk materials to at least one target silo for temporary storage,
(d) stationing the outgoing transport vehicles in at least one loading station of at least one improved grain elevator loading means to prepare for loading the bulk materials into the outgoing transport vehicles using said at least one improved grain elevator loading means, and
(e) loading the bulk materials into the outgoing transport vehicles using said at least one improved grain elevator loading means.

24. The invention as defined in claim 23 further comprising an additional step of releasing the incoming transport vehicles for reuse after the step of unloading the bulk materials.

25. The invention as defined in claim 23 further comprising an additional step of releasing the outgoing transport vehicles for transporting the bulk materials to an ultimate user site.

26. The invention as defined in claim 24 further comprising an additional step of releasing the outgoing transport vehicles for transporting the bulk materials to an ultimate user site.

27. The invention as defined in claim 23 wherein said at least one improved grain elevator receiving means comprises distributing dry materials using at least one system of distribution belts that traverses at least one improved grain elevator spout floor to distribute the dry materials to at least one target silo, distributing liquid materials using at least one liquid pipeline to at least one liquid bladder target silo, and distributing gaseous materials using at least one gaseous pipeline to at least one gaseous bladder target silo.

28. The invention as defined in claim 24 wherein said at least one improved grain elevator receiving means comprises distributing dry materials using at least one system of distribution belts that traverses at least one improved grain elevator spout floor to distribute the dry materials to at least one target silo, distributing liquid materials using at least one liquid pipeline to at least one liquid bladder target silo, and distributing gaseous materials using at least one gaseous pipeline to at least one gaseous bladder target silo.

29. The invention as defined in claim 25 wherein said at least one improved grain elevator receiving means comprises distributing dry materials using at least one system of distribution belts that traverses at least one improved grain elevator spout floor to distribute the dry materials to at least one target silo, distributing liquid materials using at least one liquid pipeline to at least one liquid bladder target silo, and distributing gaseous materials using at least one gaseous pipeline to at least one gaseous bladder target silo.

30. The invention as defined in claim 26 wherein said at least one improved grain elevator receiving means comprises distributing dry materials using at least one system of distribution belts that traverses at least one improved grain elevator spout floor to distribute the dry materials to at least one target silo, distributing liquid materials using at least one liquid pipeline to at least one liquid bladder target silo, and distributing gaseous materials using at least one gaseous pipeline to at least one gaseous bladder target silo.

31. The invention as defined in claim 27 wherein said at least one improved grain elevator loading means comprises retrieving dry materials discharged from said at least one target silo using at least one ducting system to transfer the dry materials discharged from said at least one target silo to said at least one vertical bucket elevator which conveys the dry materials vertically to said at least one improved grain elevator spout floor, before the step of stationing the outgoing transport vehicles in at least one loading station under at least one improved grain elevator load out spout to prepare for loading the dry materials into the outgoing transport vehicles, retrieving liquid materials using at least one liquid pipeline from at least one liquid bladder target silo for loading liquid materials into transport vehicles stationed in said at least one loading station, and retrieving gaseous materials using at least one gaseous pipeline from at least one gaseous bladder target silo for loading gaseous materials into transport vehicles stationed in said at least one loading station.

32. The invention as defined in claim 28 wherein said at least one improved grain elevator loading means comprises retrieving dry materials discharged from said at least one target silo using at least one ducting system to transfer the dry materials discharged from said at least one target silo to said at least one vertical bucket elevator which conveys the dry materials vertically to said at least one improved grain elevator spout floor, before the step of stationing the outgoing transport vehicles in at least one loading station under at least one improved grain elevator load out spout to prepare for loading the dry materials into the outgoing transport vehicles, retrieving liquid materials using at least one liquid pipeline from at least one liquid bladder target silo for loading liquid materials into transport vehicles stationed in said at least one loading station, and retrieving gaseous materials using at least one gaseous pipeline from at least one gaseous bladder target silo for loading gaseous materials into transport vehicles stationed in said at least one loading station.

33. The invention as defined in claim 29 wherein said at least one improved grain elevator loading means comprises retrieving dry materials discharged from said at least one target silo using at least one ducting system to transfer the dry materials discharged from said at least one target silo to said at least one vertical bucket elevator which conveys the dry materials vertically to said at least one improved grain elevator spout floor, before the step of stationing the outgoing transport vehicles in at least one loading station under at least one improved grain elevator load out spout to prepare for loading the dry materials into the outgoing transport vehicles, retrieving liquid materials using at least one liquid pipeline from at least one liquid bladder target silo for loading liquid materials into transport vehicles stationed in said at least one loading station, and retrieving gaseous materials using at least one gaseous pipeline from at least one gaseous bladder target silo for loading gaseous materials into transport vehicles stationed in said at least one loading station.

34. The invention as defined in claim 30 wherein said at least one improved grain elevator loading means comprises retrieving dry materials discharged from said at least one target silo using at least one ducting system to transfer the dry materials discharged from said at least one target silo to said at least one vertical bucket elevator which conveys the dry materials vertically to said at least one improved grain elevator spout floor, before the step of stationing the outgoing transport vehicles in at least one loading station under at least one improved grain elevator load out spout to prepare for loading the dry materials into the outgoing transport vehicles, retrieving liquid materials using at least one liquid pipeline from at least one liquid bladder target silo for loading liquid materials into transport vehicles stationed in said at least one loading station, and retrieving gaseous materials using at least one gaseous pipeline from at least one gaseous bladder target silo for loading gaseous materials into transport vehicles stationed in said at least one loading station.

35. A method of transloading bulk materials from an incoming transport vehicle to an outgoing transport vehicle to minimize demurrage of both the incoming transport vehicle and the outgoing transport vehicle, comprising the steps of:
a. stationing the incoming transport vehicles in at least one unloading station of at least one improved grain elevator receiving means to prepare to unload the bulk materials using said at least one improved grain elevator receiving means,
b. unloading the bulk materials using said at least one improved grain elevator receiving means,
c. conveying the bulk materials to at least one target silo for temporary storage,
d. stationing the outgoing transport vehicles in at least one loading station of at least one improved grain elevator loading means to prepare for loading the bulk materials into the outgoing transport vehicles using said at least one improved grain elevator loading means, and
e. loading the bulk materials into the outgoing transport vehicles using said at least one improved grain elevator loading means.

36. The invention as defined in claim 35 further comprising an additional step of releasing the incoming transport vehicles for reuse after the step of unloading the bulk materials.

37. The invention as defined in claim 35 further comprising an additional step of releasing the outgoing transport vehicles for transporting the bulk materials to an ultimate user site.

38. The invention as defined in claim 36 further comprising an additional step of releasing the outgoing transport vehicles for transporting the bulk materials to an ultimate user site.

39. The invention as defined in claim 35 wherein said at least one improved grain elevator receiving means comprises distributing dry materials using at least one system of distribution belts that traverses at least one improved grain elevator spout floor to distribute the dry materials to at least one target silo, distributing liquid materials using at least one liquid pipeline to at least one liquid bladder target silo, and distributing gaseous materials using at least one gaseous pipeline to at least one gaseous bladder target silo.

40. The invention as defined in claim 36 wherein said at least one improved grain elevator receiving means comprises distributing dry materials using at least one system of distribution belts that traverses at least one improved grain elevator spout floor to distribute the dry materials to at least one target silo, distributing liquid materials using at least one liquid pipeline to at least one liquid bladder target silo, and distributing gaseous materials using at least one gaseous pipeline to at least one gaseous bladder target silo.

41. The invention as defined in claim 37 wherein said at least one improved grain elevator receiving means comprises distributing dry materials using at least one system of distribution belts that traverses at least one improved grain elevator spout floor to distribute the dry materials to at least one target silo, distributing liquid materials using at least one liquid pipeline to at least one liquid bladder target silo, and distributing gaseous materials using at least one gaseous pipeline to at least one gaseous bladder target silo.

42. The invention as defined in claim 38 wherein said at least one improved grain elevator receiving means comprises distributing dry materials using at least one system of distribution belts that traverses at least one improved grain elevator spout floor to distribute the dry materials to at least one target silo, distributing liquid materials using at least one liquid pipeline to at least one liquid bladder target silo, and distributing gaseous materials using at least one gaseous pipeline to at least one gaseous bladder target silo.

43. The invention as defined in claim 39 wherein said at least one improved grain elevator loading means comprises retrieving dry materials discharged from said at least one target silo using at least one ducting system to transfer the dry materials discharged from said at least one target silo to said at least one vertical bucket elevator which conveys the dry materials vertically to said at least one improved grain elevator spout floor, before the step of stationing the outgoing transport vehicles in at least one loading station under at least one improved grain elevator load out spout to prepare for loading the dry materials into the outgoing transport vehicles, retrieving liquid materials using at least one liquid pipeline from at least one liquid bladder target silo for loading liquid materials into transport vehicles stationed in said at least one loading station, and retrieving gaseous materials using at least one gaseous pipeline from at least one gaseous bladder target silo for loading gaseous materials into transport vehicles stationed in said at least one loading station.

44. The invention as defined in claim 40 wherein said at least one improved grain elevator loading means comprises retrieving dry materials discharged from said at least one target silo using at least one ducting system to transfer the dry materials discharged from said at least one target silo to said at least one vertical bucket elevator which conveys the dry materials vertically to said at least one improved grain elevator spout floor, before the step of stationing the outgoing transport vehicles in at least one loading station under at least one improved grain elevator load out spout to prepare for loading the dry materials into the outgoing transport vehicles, retrieving liquid materials using at least one liquid pipeline from at least one liquid bladder target silo for loading liquid materials into transport vehicles stationed in said at least one loading station, and retrieving gaseous materials using at least one gaseous pipeline from at least one gaseous bladder target silo for loading gaseous materials into transport vehicles stationed in said at least one loading station.

45. The invention as defined in claim 41 wherein said at least one improved grain elevator loading means comprises retrieving dry materials discharged from said at least one target silo using at least one ducting system to transfer the dry materials discharged from said at least one target silo to said at least one vertical bucket elevator which conveys the dry materials vertically to said at least one improved grain elevator spout floor, before the step of stationing the outgoing transport vehicles in at least one loading station under at least one improved grain elevator load out spout to prepare for loading the dry materials into the outgoing transport vehicles, retrieving liquid materials using at least one liquid pipeline from at least one liquid bladder target silo for loading liquid materials into transport vehicles stationed in said at least one loading station, and retrieving gaseous materials using at least one gaseous pipeline from at least one gaseous bladder target silo for loading. gaseous materials into transport vehicles stationed in said at least one loading station.

46. The invention as defined in claim 42 wherein said at least one improved grain elevator loading means comprises retrieving dry materials discharged from said at least one target silo using at least one ducting system to transfer the dry materials discharged from said at least one target silo to said at least one vertical bucket elevator which conveys the dry materials vertically to said at least one improved grain elevator spout floor, before the step of stationing the outgoing transport vehicles in at least one loading station under at least one improved grain elevator load out spout to prepare for loading the dry materials into the outgoing transport vehicles, retrieving liquid materials using at least one liquid pipeline from at least one liquid bladder target silo for loading liquid materials into transport vehicles stationed in said at least one loading station, and retrieving gaseous materials using at least one gaseous pipeline from at least one gaseous bladder target silo for loading gaseous materials into transport vehicles stationed in said at least one loading station.

47. A method of loading bulk materials to an outgoing transport vehicle to minimize demurrage of the outgoing transport vehicle, comprising the steps of:
a. stationing the outgoing transport vehicles in at least one loading station of at least one improved grain elevator loading means to prepare for loading the bulk materials into the outgoing transport vehicles using said at least one improved grain elevator loading means, and
b. loading the bulk materials into the outgoing transport vehicles using said at least one improved grain elevator loading means.

48. The invention as defined in claim 47 further comprising an additional step of
c. releasing the outgoing transport vehicle for transporting the bulk materials to an ultimate user site.

49. The invention as defined in claim 47 wherein the outgoing transport vehicle is a truck.

50. The invention as defined in claim 48 wherein the outgoing transport vehicle is a truck.

51. The invention as defined in claim 47 wherein the outgoing transport vehicle is a pipeline.

52. The invention as defined in claim 48 wherein the outgoing transport vehicle is a pipeline.

53. The invention as defined in claim 47 wherein the outgoing transport vehicle is a ship.

54. The invention as defined in claim 48 wherein the outgoing transport vehicle is a ship.

55. A method of unloading bulk materials from an incoming transport vehicle to minimize the demurrage of the incoming transport vehicle, comprising the steps of:
a. stationing the incoming transport vehicles in at least one unloading station of at least one improved grain elevator receiving means to prepare to unload the bulk materials using said at least one improved grain elevator receiving means, and
b. unloading the bulk materials using said at least one improved grain elevator receiving means.

56. The invention as defined in claim 55 further comprising an additional step of
c. releasing the incoming transport vehicle for reuse.

57. The invention as defined in claim 55 wherein the incoming transport vehicle is a freight car.

58. The invention as defined in claim 56 wherein the incoming transport vehicle is a freight car.

59. The invention as defined in claim 55 wherein the incoming transport vehicle is a pipeline.

60. The invention as defined in claim 56 wherein the incoming transport vehicle is a pipeline.

61. The invention as defined in claim 55 wherein the incoming transport vehicle is a ship.

62. The invention as defined in claim 56 wherein the incoming transport vehicle is a ship.
